(19) United States
(12) Patent Application Publication
(10) Pub. No.: US 2021/0372204 A1
(43) Pub. Date: Dec. 2, 2021

(54) SYSTEM AND METHOD FOR COUPLING UPPER AND LOWER COMPLETIONS

(71) Applicant: SCHLUMBERGER TECHNOLOGY CORPORATION, Sugar Land, TX (US)

(72) Inventor: Dinesh Patel, Sugar Land, TX (US)

(21) Appl. No.: 16/651,571

(22) PCT Filed: Sep. 20, 2018
(86) PCT No.: PCT/US2018/052041

§ 371 Date: Mar. 27, 2020

Related U.S. Application Data
(60) Provisional application No. 62/565,465, filed on Sep. 29, 2017.

(51) Int. Cl. E21B 17/02

(52) U.S. Cl. CPC E21B 17/02

(57) ABSTRACT

A technique facilitates joining of an upper completion with a lower completion in a manner which enables adjustability. According to an embodiment, an assembly may be used to join the upper completion to the lower completion for joint deployment downhole into a wellbore. However, the assembly is constructed to provide adjustability for accommodating various conditions which may occur downhole. For example, the assembly may be actuatable to enable release of the upper completion and/or contraction to adjust positioning of the upper completion

### CROSS-REFERENCE TO RELATED APPLICATION

The present document is based on and claims priority to U.S. Provisional Application Ser. No. 62/565,465, filed Sep. 29, 2017, which is incorporated herein by reference in its entirety.

### BACKGROUND

Hydrocarbon fluids such as oil and natural gas are obtained from a subterranean geologic formation, referred to as a reservoir, by drilling a wellbore that penetrates the hydrocarbon-bearing formation. Once the wellbore is drilled, various forms of well completion components may be installed to control and enhance the efficiency of producing the various fluids from the reservoir. In various applications, the well completion components may be divided into a lower completion and an upper completion which are joined together. However, existing mechanisms for joining the lower and upper completions can be problematic under various conditions.

### SUMMARY

In general, a system and methodology provide an assembly for joining an upper completion with a lower completion. The assembly may be used to join the upper completion to the lower completion for combined deployment downhole into a wellbore. However, the assembly is constructed to provide adjustability for accommodating various conditions which may occur downhole. For example, the assembly may be actuatable to enable easy release of the upper completion and/or contraction to adjust positioning of the upper completion.

However, many modifications are possible without materially departing from the teachings of this disclosure. Accordingly, such modifications are intended to be included within the scope of this disclosure as defined in the claims.

### BRIEF DESCRIPTION OF THE DRAWINGS

Certain embodiments of the disclosure will hereafter be described with reference to the accompanying drawings, wherein like reference numerals denote like elements. It should be understood, however, that the accompanying figures illustrate the various implementations described herein and are not meant to limit the scope of various technologies described herein, and:

FIG. 1 is an illustration of an example of a well system having an upper completion coupled with a lower completion via a latch assembly, according to an embodiment of the disclosure;

FIG. 2 is an illustration similar to that of FIG. 1 but showing the latch assembly in a different operational position, according to an embodiment of the disclosure;

FIG. 3 is an illustration of an example of a remaining lower completion after the latch assembly is disconnected and the upper completion is pulled out of hole, according to an embodiment of the disclosure;

FIG. 4 is an illustration of an example of the well system after an upper completion has been run in hole without the latch assembly, according to an embodiment of the disclosure;

FIG. 5 is an illustration of the well system having an upper completion coupled with a lower completion via another example of the latch assembly, according to an embodiment of the disclosure;

FIG. 6 is an illustration similar to that of FIG. 5 but showing the upper completion unlocked from the lower completion, according to an embodiment of the disclosure;

FIG. 7 is an illustration of the well system having an upper completion coupled with a lower completion via another example of the latch assembly, according to an embodiment of the disclosure;

FIG. 8 is an illustration similar to that of FIG. 7 but showing the latch assembly in a different operational position, according to an embodiment of the disclosure;

FIG. 9 is an illustration of the well system having an upper completion coupled with a lower completion via another example of the latch assembly, according to an embodiment of the disclosure;

FIG. 10 is an illustration of the well system having an upper completion coupled with a lower completion via another example of the latch assembly, according to an embodiment of the disclosure;

FIG. 11 is an illustration of a well system having an upper completion coupled with a lower completion via an example of a contraction joint, according to an embodiment of the disclosure;

FIG. 12 is an illustration similar to that of FIG. 11 but showing the contraction joint in a different operational position, according to an embodiment of the disclosure;

FIG. 13 is an illustration similar to that of FIG. 11 but showing the contraction joint in a different operational position, according to an embodiment of the disclosure;

FIG. 14 is an illustration of a well system having an upper completion coupled with a lower completion via another example of a contraction joint, according to an embodiment of the disclosure; and

FIG. 15 is an illustration similar to that of FIG. 14 but showing the contraction joint in a different operational position, according to an embodiment of the disclosure.

### DETAILED DESCRIPTION

In the following description, numerous details are set forth to provide an understanding of some embodiments of the present disclosure. However, it will be understood by those of ordinary skill in the art that the system and/or methodology may be practiced without these details and that numerous variations or modifications from the described embodiments may be possible.

The present disclosure generally relates to a well system and methodology which facilitate joining an upper completion with a lower completion in a manner which simplifies certain operations, e.g. workover operations. The upper completion and the lower completion are joined by an assembly so the entire well string may be deployed downhole into a wellbore. However, the assembly is constructed to provide adjustability for accommodating various conditions which may occur downhole. For example, the assembly may be actuatable to enable easy release of the upper completion to facilitate a workover operation or other desired operation. In some embodiments, the assembly may be actuatable in a manner which enables a desired contraction so as to enable adjustment of the positioning of the upper completion in the wellbore even if the lower completion becomes stuck prematurely.

According to an embodiment, hydraulic inputs and/or mechanical inputs may be used to selectively enable separation of the upper completion from the lower completion without cutting of tubing. In some applications, the assembly is constructed as a differential pressure actuated anchor latch combined with an expansion-contraction joint. However, other embodiments of the assembly may be constructed with a contraction joint which is maintained in an expanded/extended configuration by tubing pressure as the lower completion, assembly, and upper completion are deployed downhole. In this embodiment, the tubing pressure may be selectively equalized with an external pressure to selectively enable collapse and contraction of the contraction joint.

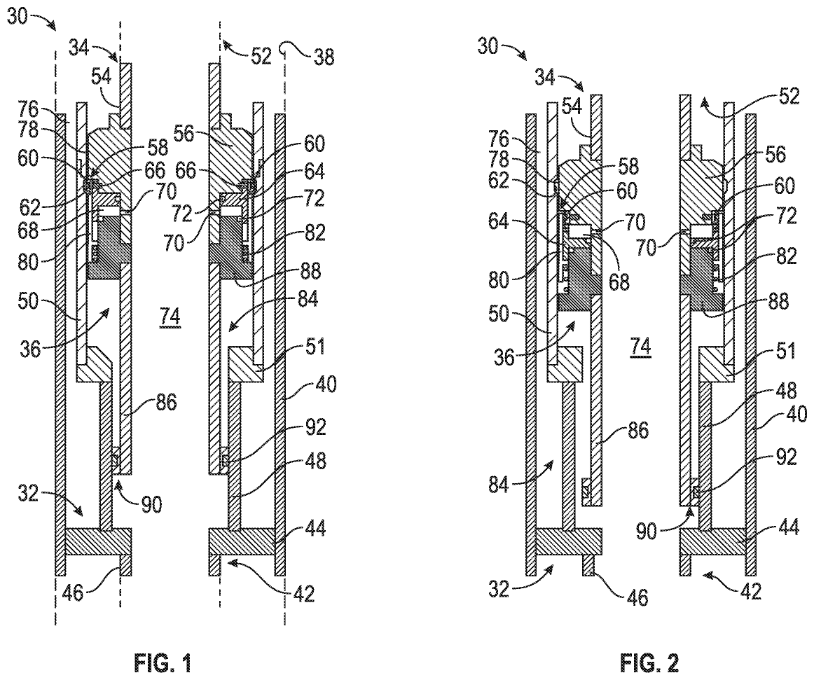

Referring generally to FIG. 1, an embodiment of a well system 30 is illustrated. In this example, the well system 30 comprises a lower completion 32, an upper completion 34, and a latch assembly 36 coupling the upper completion 34 to the lower completion 32. By way of example, the well system 30 may be deployed downhole into a wellbore 38 which, in some applications, is lined with a casing 40.

Depending on the parameters of a given application, the lower completion 32, upper completion 34, and latch assembly 36 may comprise a variety of components and features. To facilitate explanation, however, the lower completion 32 is illustrated as comprising a tubing string 42 sealable with respect to casing 40 via a packer 44. The tubing string 42 may comprise tubing 46 and a variety of other components, e.g. sand screen assemblies, selected according to the parameters of a given well operation.

In the illustrated example, the lower completion 32 also comprises a polished bore receptacle 48 disposed generally above the packer 44 and coupled with the packer 44 (or with other suitable component). Additionally, the lower completion 32 may comprise a locking housing 50 sized to receive the latch assembly 36 therein. The locking housing 50 may be secured to polished bore receptacle 48 via a suitable connector 51, e.g. a welded and/or threaded connector. The upper completion 34 also comprises a tubing string 52 having an upper tubing 54 which may be combined with various other components.

The latch assembly 36 joins the upper and lower completions 32, 34 and is releasably coupled with at least one of the lower completion 32 and the upper completion 34. For example, the latch assembly 36 may comprise a latch housing 56 attached to upper tubing 54 of upper completion 34 via threaded engagement, welding, or other suitable attachment technique.

In the illustrated example, the latch assembly 36 further comprises a locking member 58 which effectively axially secures the upper completion 34 to the lower completion 32 when in a locked position. The locking member 58 may be in the form of a locking dog 60 received in a corresponding recess 62 formed in the interior surface of locking housing 50 when in the locked position. In some embodiments, the locking dog 60 may comprise a plurality of locking dogs 60.

The latch assembly 36 also comprises a piston 64 which is shiftable between a first position (see FIG. 1) and a second position (see FIG. 2). In the first position, the piston 64 holds the locking member 58, e.g. locking dog 60, in the locked position within recess 62, thus preventing axial movement of upper completion 34 with respect to lower completion 32. In some embodiments, the locking member 58, e.g. each locking dog 60, may initially be secured to the piston 64 via a shear member 66, e.g. a shear pin.

With additional reference to FIG. 2, the piston 64 is selectively shiftable via application of a pressure differential. For example, the piston 64 may be shifted from the first position, in which locking member 58 is locked in corresponding recess 62, to the second position, releasing the locking member 58 from the recess 62. The shifting of piston 64 may be achieved by application of, for example, increased annulus pressure to achieve a sufficient pressure differential acting on piston 64.

In the example illustrated, the piston 64 is slidably mounted in a cavity 68 and a passage(s) 70 extends from the cavity 68 (between piston seals 72) to a completion or tubing interior 74. The tubing interior 74 is located within latch assembly 36, upper completion 34, and lower completion 32. By way of example, the passage or passages 70 may extend through a wall of latch housing 56 to interior 74. The other side of piston 64 is exposed to an annulus 76 surrounding the upper completion 34 via an annulus passage 78.

When sufficient pressure is applied in the annulus 76, a pressure differential is established between the annulus side of the piston 64 and the internal tubing side of piston 64. A sufficient pressure differential acting on piston 64 effectively shears the shear member(s) 66 and shifts the piston 64 to the released/unlocked position illustrated in FIG. 2. This allows release of the locking member 58 so the upper completion 34 is able to shift axially with respect to the lower completion 32. In some embodiments, a dog cover sleeve 80 may be biased by a spring 82 to slide over the released locking dogs 60 and to capture the locking dogs 60 against latch housing 56. In FIG. 2, the latch assembly 36 is shown in a collapsed position which may occur, for example, when the lower completion 32 is on the bottom of wellbore 38.

In the illustrated embodiment, the latch assembly 36 also comprises an expansion-contraction joint 84. By way of example, the expansion-contraction joint 84 may comprise a tubing 86 secured to a sub housing 88 which, in turn, is secured to latch housing 56. The tubing 86 may be secured to sub housing 88 via threaded engagement, welded engagement, or other suitable coupling mechanism. Similarly, the sub housing 88 may be secured to latch housing 56 via threaded engagement, welded engagement, or other suitable coupling mechanism.

The tubing 86 also is coupled with a seal assembly 90 located generally on an opposite end of the tubing 86 relative to sub housing 88. The seal assembly 90 may comprise a suitable seal element 92 oriented for sealing engagement with an inside surface of the polished bore receptacle 48. The slidable seal element 92 enables maintenance of a seal between the upper completion 34 and the lower completion 32 during limited axial movement of the upper completion 34 relative to the lower completion 32 after release of locking member 58.

In the embodiment illustrated, the sub housing 88 and the latch housing 56 cooperate to form the cavity 68. In this example, piston seals 72 comprise a pair of piston seals 72 with one mounted on piston 64 for sliding engagement along an external surface of latch housing 56 and the other mounted on sub housing 88 for sliding engagement along an interior surface of piston 64. By way of example, the piston seals 72 may be in the form of non-elastomeric seals held in place by corresponding seal nuts or other suitable securing mechanisms. In this configuration, the latch assembly 36 effectively forms a tubing differential pressure actuated contraction/expansion joint and anchor latch which may be run-in-hole while the contraction joint 84 is locked in a desired position, e.g. a mid-position.

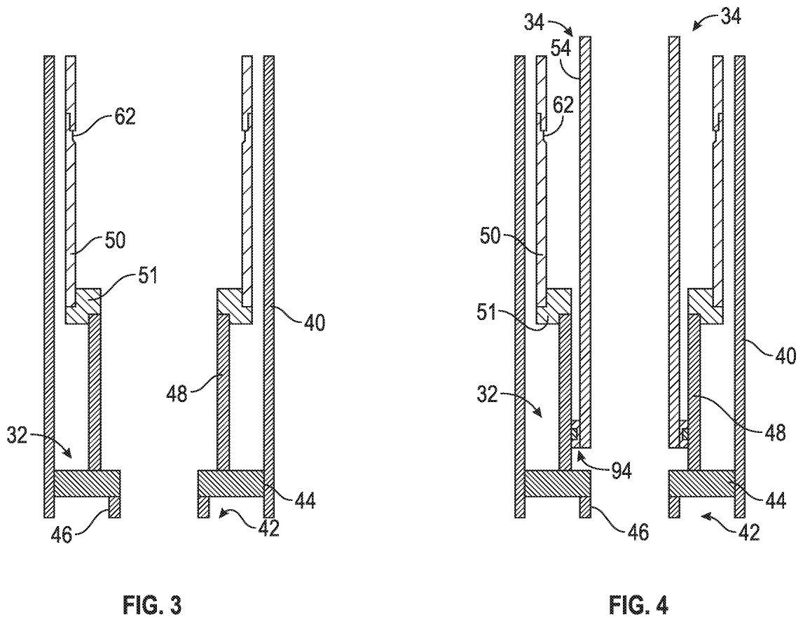

After shifting piston 64 and releasing locking member 58 from the locked position, the ability to axially move upper completion 34 relative to lower completion 32 enables removal of upper completion 34, as illustrated in FIG. 3. For example, the upper completion 34 may be removed and retrieved to the surface to facilitate a workover operation or other well related operation. Once the workover operation or other well related operation is completed a subsequent upper completion 34 may be deployed downhole for engagement with the polished bore receptacle 48 of lower completion 32, as illustrated in FIG. 4. At this stage, the latch assembly 36 may no longer be desired and the upper completion 34 may simply be combined with an upper completion seal assembly 94 oriented for sealing engagement with the interior surface of polished bore receptacle 48 as illustrated.

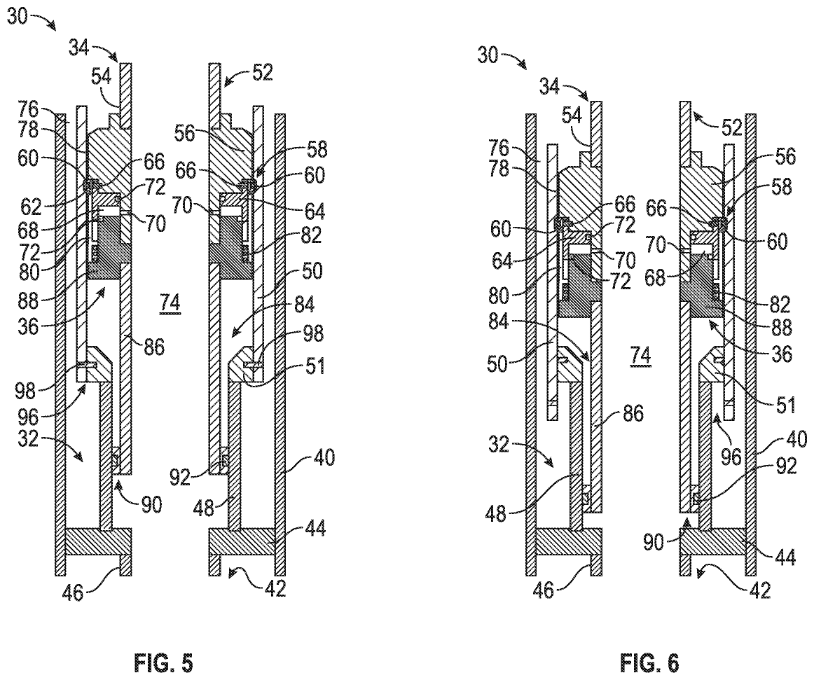

Referring generally to FIG. 5, another embodiment of latch assembly 36 is illustrated. In this example, the latch assembly 36 comprises a contingency release 96. The contingency release 96 may be used to enable mechanical separation of the upper completion 34 from the lower completion 32 if, for example, the locking member 58 fails to release.

In the embodiment illustrated, the contingency release 96 comprises a shear member 98, e.g. a plurality of shear pins, connecting the locking housing 50 with the connector 51. The shear pins 98 may be in the form of high-value shear pins which shear upon application of a high, predetermined tensile loading applied via upper completion 34. Upon application of the sufficient tensile load, the shear member/shear pins 98 are sheared to release the locking housing 50 and the upper completion 34 from lower completion 32. Once sheared, the locking housing 50 is able to slide relative to connector 51 and polished bore receptacle 48 as illustrated in FIG. 6. If the upper completion 34 is to be pulled out of hole and retrieved to the surface, that action can be performed following actuation of contingency release 96, e.g. after shearing of shear member 98.

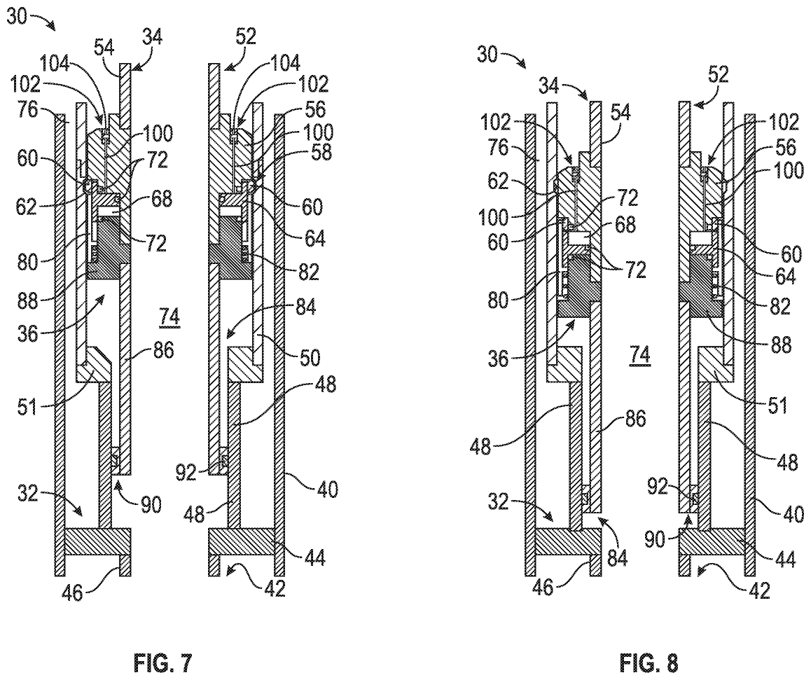

Referring generally to FIG. 7, another embodiment of the latch assembly 36 is illustrated. In this example, the latch assembly 36 is in the form of an absolute annulus pressure actuated system including the contraction joint 84. As illustrated in FIG. 7, this embodiment omits passages 70 and instead provides a passage or passages 100 routed from the annulus 76 directly to cavity 68 on the annulus side of piston 64. The passages 100 may be routed through latch housing 56 as illustrated.

In this embodiment, the cavity 68 may be an atmosphere chamber and each of the passages 100 may initially be blocked by a suitable flow blocking member 102. The flow blocking members 102 may comprise rupture discs 104 or other suitable flow blocking members, e.g. valves, used to isolate the piston 64 from pressure in the annulus 76 when the piston 64 and the locking member 58 are in the locked position shown in FIG. 7.

However, when sufficient pressure is applied in annulus 76 the flow blocking member 102 is transitioned to a flow position. If rupture discs 104 are used, for example, the pressure applied in the annulus 76 ruptures the discs 104 so that annulus pressure is able to act on piston 64 so as to create a sufficient pressure differential between the annulus pressure and the atmospheric chamber pressure on the other side of piston 64. This sufficient pressure differential causes piston 64 to shift to an unlocked position which unlocks and releases locking member 58, e.g. dogs 60, as illustrated in FIG. 8.

Once the piston 64 is shifted, the cavity/chamber 68 is at annulus pressure. At this stage, the upper completion 34 is effectively unlocked with respect to the lower completion 32 and the contraction joint 84 can function as described above with respect to the previous embodiment. As further described above, the ability to axially move upper completion 34 relative to lower completion 32 enables removal of upper completion 34 (see FIG. 3). The upper completion 34 may be removed and retrieved to the surface to facilitate a workover operation or other well related operation. Once the workover operation or other well related operation is completed the subsequent upper completion 34 may be deployed downhole for engagement with the polished bore receptacle 48 of lower completion 32 (see FIG. 4).

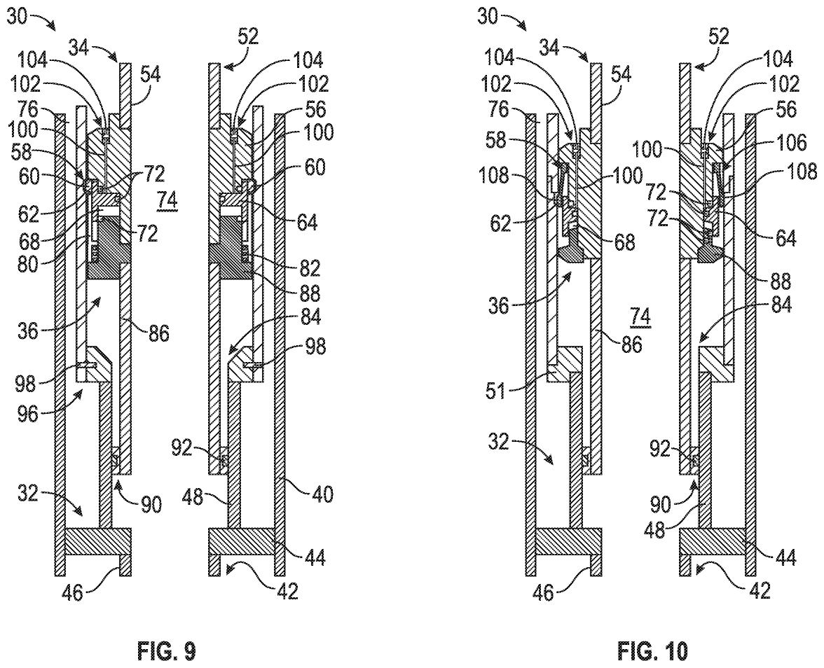

Referring generally to FIG. 9, another embodiment of latch assembly 36 is illustrated. This embodiment is very similar to the embodiment illustrated in FIGS. 7 and 8. However, this embodiment of latch assembly 36 again comprises contingency release 96. As described above, contingency release 96 may be used to enable mechanical separation of the upper completion 34 from the lower completion 32 if, for example, the locking member 58 fails to release. The contingency release 96 may comprise shear member 98 which shears upon application of sufficient tensile load to release the locking housing 50 and the upper completion 34 from lower completion 32.

Referring generally to FIG. 10, another embodiment of latch assembly 36 is illustrated. In this example, the locking member 58 is in the form of a collet 106 having collet finger ends 108 which are received in recess 62 and held in this locked position by piston 64. The piston 64 may be shifted via establishment of a sufficient differential pressure acting on the piston 64 as described with respect to the embodiments above. In the example illustrated, passages 100 are used to provide an absolute annulus pressure actuated latch assembly 36, as described above with reference to the embodiment illustrated in FIGS. 7 and 8.

Once the piston 64 is shifted to the unlocked position, the collet finger ends 108 are released which allows contraction or expansion of the expansion-contraction joint 84. Once the piston 64 and collet 106 are unlocked, the upper completion 34 also may be separated from the lower completion 32 and retrieved to the surface to enable a workover operation or other desired operation.

It should be noted, components of the latch assembly, such as the latch housing 56 and the sub housing 88 may have a variety of configurations. In the embodiment illustrated in FIG. 10, for example, the tubing 86 of expansion-contraction joint 84 is coupled directly with latch housing 56 and sub housing 88 is mounted along the exterior of latch housing 56.

Referring generally to FIG. 11, another embodiment of well system 30 is illustrated in which the upper completion 34 is coupled with the lower completion 32 via a contraction joint 110. In this example, the contraction joint 110 comprises a first housing 112 having an interior surface 114 forming a polished bore receptacle. A second housing 116 is slidably positioned within the first housing 112 and sealed with respect to the interior surface 114 via a seal element 118, e.g. one or more ring type seals extending about the exterior of second housing 116. In various applications, the first housing 112 and the second housing 116 may each be generally tubular in shape.

Additionally, the first housing 112 and the second housing 116 may be coupled with the first completion 34 and the second completion 32 in a desired orientation. For example, the first housing 112 may be coupled with the lower completion 32 via a suitable attachment body 120.

In the illustrated example, the second housing 116 is generally tubular and has an expanded end 122 relative to a tubular section 124 to which the expanded end 122 is attached. A retainer 126, e.g. a retainer housing, may be secured to the end of first housing 112 to retain the second housing 116 for slidable movement within first housing 112 along interior surface 114. In some embodiments, the retainer 126 may have a plugged passage 128 which may be selectively open to enable communication of pressure, e.g. release of pressure. It should be noted various seals 130 may be positioned between components of contraction joint 110 to ensure pressure integrity is maintained along interior 74 between lower completion 32 and upper completion 34 during operation of contraction joint 110.

Depending on the application, the stroke of the contraction joint 110 as seal element 118 moves along interior surface 114 may vary. For some downhole operations, the contraction joint 110 may be constructed with a stroke of 30 feet or more to accommodate positioning of the upper completion 34 in the event the lower completion 32 becomes stuck shortly before a predetermined final position in the wellbore 38, e.g. in a horizontal wellbore. In some embodiments, the contraction joint 110 also may comprise a retention member 132, e.g. a collet. The retention member 132 holds the first housing 112 and the second housing 116 in the extended configuration illustrated in FIG. 11 during initial stages of deployment.

However, as the lower completion 32, contraction joint 110, and an upper completion 34 are deployed downhole into wellbore 38, the tubing pressure (Pt), e.g. hydrostatic pressure, increases. This tubing pressure maintains the contraction joint 110 in its expanded configuration as the contraction joint 110 moves farther downhole. The expanded end 122 of second housing 116 provides a greater surface area on which the tubing pressure (Pt) acts relative to the surface area acted on by the annulus pressure (Pa). This ensures that adequate force is applied to the second housing 116 to bias the second housing 116 in a direction away from the first housing 112, thus maintaining the second housing 116 in an extended/expanded configuration relative to first housing 112.

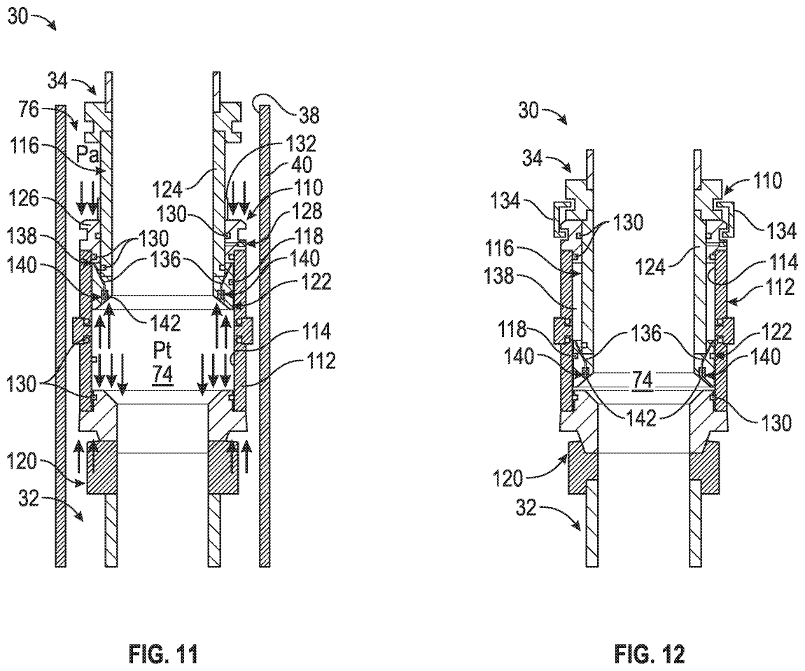

During shipping or other handling procedures, however, the pressures acting on second housing 116 are not present or limited. Consequently, the contraction joint may be shifted to a contracted position, as illustrated in FIG. 12. If the embodiment comprises retention member 132, the retention member 132 can simply be released to allow contraction of joint 110 until the joint 110 is assembled at the wellsite for deployment downhole into wellbore 38. Additionally, shipping retention members 134 may be used to maintain the contraction joint 110 in the contracted configuration during shipping and/or other types of handling.

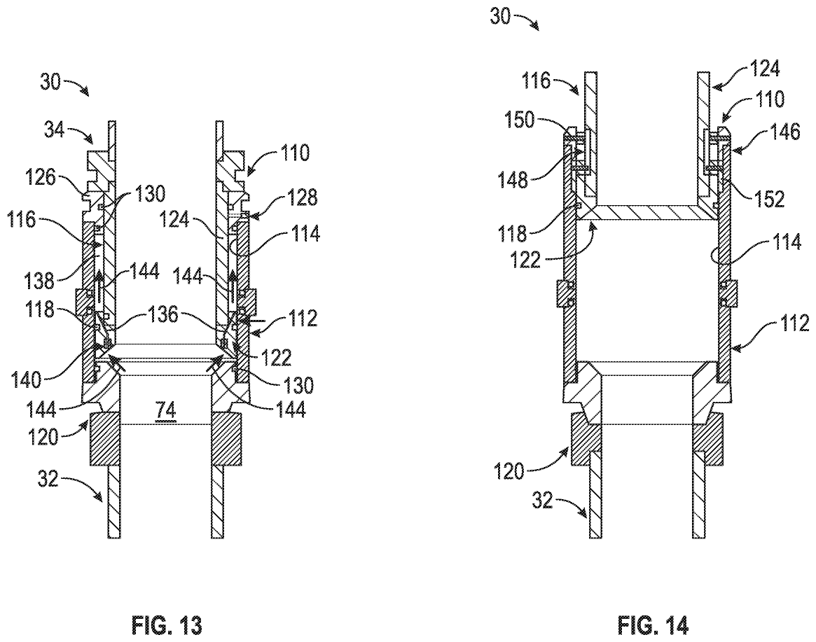

With further reference to FIG. 13, the contraction joint also comprises a passage or passages 136 which are routed through the expanded end 122 of second housing 116 between interior 74 and a chamber 138, e.g. an atmospheric chamber, located externally of the second housing 116. Each passage 136 is plugged with a pressure blocking member 140 which may comprise a rupture disc 142 or other suitable releasable pressure blocking member.

If the lower completion 32 becomes stuck prior to reaching its final destination, the contraction joint 110 may be contracted by opening passage(s) 136 to enable equalization of pressure between tubing interior 74 and atmospheric chamber 138, as represented by arrows 144. For example, the interior 74 may be pressured up to rupture the rupture discs 142 so as to enable pressure equalization across second housing 116 and thus contraction of the contraction joint 110. The ability to contract the contraction joint 110 enables an operator to position the upper completion 34 at a desired location while maintaining sealed interior 74 between the lower completion 32 and upper completion 34.

It should be noted that the lower completion 32 may run into temporary obstacles during deployment through, for example, a deviated wellbore. In these types of situations, the second housing 116 may move axially somewhat with respect to first housing 112 and thus contraction joint effectively serves as a hydraulic spring. However once the lower completion 32 moves past the temporary obstacle, the tubing pressure (Pt) returns the contraction joint 110 to its fully expanded configuration (at least until passages 136 are opened).

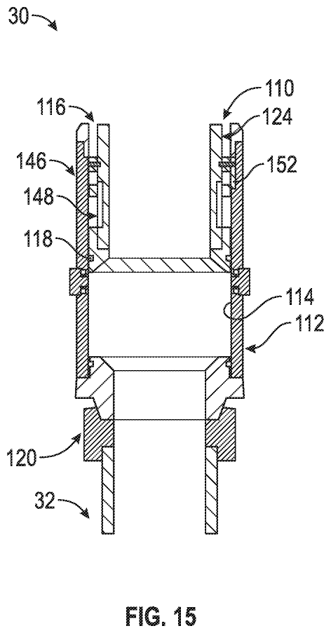

Referring generally to FIGS. 14 and 15, another embodiment of contraction joint 110 is illustrated. In this example, a mechanical device 146 releasably secures the second housing 116 in an expanded configuration with respect to first housing 112 instead of relying on the internal tubing pressure. By way of example, the mechanical device 146 may comprise a J-slot mechanism 148.

The J-slot mechanism 148 secures the second housing 116 in the expanded configuration with respect to first housing 112. However, by cycling the upper completion 34 and thus the second housing 116 up and down a predetermined number of cycles, the J-slot mechanism 148 can be actuated to release the second housing 116. At this stage, the second housing 116 is able to slide down along interior surface 114 of first housing 112 toward a suitable contracted position, as illustrated in FIG. 15.

In some embodiments, shear members 150, e.g. shear pins, may be used to help hold the relative positions of the components during running-in-hole. Additionally, this embodiment as well as the embodiment described with reference to FIGS. 11-13 may comprise features 152, e.g. splines, which prevent relative rotation of the second housing 116 with respect to the first housing 112.

Depending on the parameters of a given environment and wellbore application, the components utilized in the well system 30 may vary. The latch assembly 36 and the contraction joint 110 may selectively be used to join an upper completion with a lower completion. Additionally, the components, materials, component sizes, and various other features of the latch assembly 36 and/or contraction joint 110 may be adjusted to accommodate the environmental or operational parameters. The contraction joint 110 may be constructed with various stroke lengths to accommodate desired positioning of the upper completion 34 with respect to the lower completion 32 while maintaining a sealed coupling.

Although a few embodiments of the disclosure have been described in detail above, those of ordinary skill in the art will readily appreciate that many modifications are possible without materially departing from the teachings of this disclosure. Accordingly, such modifications are intended to be included within the scope of this disclosure as defined in the claims.

1. A system for use in a well, comprising:
a lower completion;
an upper completion; and
a latch assembly coupling the upper completion to the lower completion, the latch assembly comprising:
a locking member axially securing the upper completion to the lower completion when in a locked position, wherein the locking member comprises a dog;
a piston shiftable between a first position holding the locking member in the locked position and a second position releasing the locking member from the locked position upon application of a sufficient pressure differential on the piston; and
an expansion-contraction joint allowing relative axial movement between the upper completion and the lower completion, when the locking member is released from the locked position.

2. (canceled)

3. (canceled)

4. The system as recited in claim 1, wherein the sufficient pressure differential applied to the piston to release the locking member is established between an interior of the upper completion and an annulus around the upper completion when sufficient annulus pressure is applied.

5. The system as recited in claim 1, wherein the sufficient pressure differential applied to the piston to release the locking member is established between an atmosphere chamber and an annulus around the upper completion when sufficient annulus pressure is applied.

6. The system as recited in claim 5, wherein a rupture disc is used to isolate the piston from pressure in the annulus when the locking member is in the locked position.

7. The system as recited in claim 1, further comprising a shear member positioned to enable separation of the upper completion from the lower completion upon application of sufficient tensile loading to the upper completion.

8.-12. (canceled)

13. A system for use in a well, comprising:
a lower completion;
an upper completion having a tubing; and
a contraction joint coupling the upper completion to the lower completion, the contraction joint comprising:
a first housing having an interior surface; and
a second housing slidably positioned within the first housing and sealed along the interior via a seal element, the second housing being biased to an expanded configuration with respect to the first housing via tubing pressure applied down through the tubing to an interior of the contraction joint, the second housing further having a release mechanism actuatable to selectively release the second housing for contraction with respect to the first housing.

14. The system as recited in claim 13, wherein the release mechanism comprises a passage extending between the interior and a chamber external to the second housing, the passage being blocked by a pressure member actuatable via increased tubing pressure to open the passage and to thus release the second housing for axial contraction relative to the first housing.

15. The system as recited in claim 13, wherein the release mechanism comprises a J-slot mechanism.

16. The system as recited in claim 14, wherein the pressure member comprises a rupture disc.

17. The system as recited in claim 14, wherein the chamber comprises an atmospheric chamber.

18. The system as recited in claim 13, wherein the second housing is prevented from rotating with respect to the first housing.

19. A method, comprising:
coupling an upper completion with a lower completion via a contraction joint having a first housing and a second housing;
holding the contraction joint in a fully expanded configuration;
moving the lower completion, the contraction joint, and the upper completion downhole into a wellbore until further movement of the lower completion is prevented;
releasing the second housing with respect to the first housing to allow contraction of the contraction joint; and
adjusting the position of the upper completion in the wellbore via contraction of the contraction joint.

20. The method as recited in claim 19, wherein holding the contraction joint in the fully expanded configuration comprises utilizing pressure in the upper completion and within the contraction joint during deployment downhole to bias the second housing in a direction away from the first housing.

21. The method as recited in claim 20, wherein holding the contraction joint in the fully expanded configuration comprises using a collet to hold the second housing with respect to the first housing until the pressure in the upper completion and the contraction joint is sufficiently high.

22. The method as recited in claim 19, wherein releasing comprises releasing a pressure member to enable communication between an interior of the contraction joint and an external chamber.

23. The method as recited in claim 22, wherein releasing comprises rupturing a rupture disc via pressure applied down through the upper completion.

24. The method as recited in claim 19, wherein releasing comprises operating a J-slot mechanism.
